(19) United States
(12) Patent Application Publication
(10) Pub. No.: US 2017/0082140 A1
(43) Pub. Date: Mar. 23, 2017

(54) Method For Producing A Mechanical Device With A Transmission Element And A Transmission Element For Transmitting A Manipulated Variable

(71) Applicant: CONTINENTAL AUTOMOTIVE GMBH, HANNOVER (DE)

(72) Inventors: DIRK FRANKENSTEIN, FLOERSHEIM-DALSHEIM (DE); BRUNO FERLING, BEINDERSHEIM (DE); JOCHEN HELD, BOLANDEN-WEIERHOF (DE)

(21) Appl. No.: 15/126,354

(22) PCT Filed: Feb. 19, 2015
(86) PCT No.: PCT/EP2015/053531

§ 371 Date: Sep. 15, 2016

(30) Foreign Application Priority Data
Mar. 17, 2014 (DE) 10 2014 204 849.4

(51) Int. Cl. F16C 7/02; F02B 37/18

(52) U.S. Cl. CPC F16C 7/02; F02B 37/186

(57) ABSTRACT

A method produces a mechanical device, in particular an exhaust gas turbocharger. The turbo charger contains an open-loop or closed-loop control device and a mechanical transmission element which is connected directly or indirectly to an actuator on one side and to an adjusting element on the other side, for transmitting a manipulated variable. The transmission element can be deformed prior to the connection to the actuator and the adjusting element and can be adapted in its deformable state to the other components of the device. After the adaptation, the transmission element is fixed by reducing the deformability thereof. The transmission element can be stiffened after the assembly and adaptation. The compensation of tolerances is made possible in this way with particularly low effort.

The invention lies in the field of mechanical engineering or machine construction and relates in particular to transmission elements with which different elements of a mechanical device are connected together statically or dynamically.

For example, a transmission element may be provided as a transmission lever for transmitting a movement, in order to transmit a drive movement or a manipulated variable. In particular for the transmission of a variable for a control or regulation system, the transmission element must be coupled to the other elements of the mechanical device optimally in its outer dimensions and positioning. Installation and mounting tolerances, such as are normally compensated by means of adjustable elements such as screws, threaded rods and other such adaptable elements, can be disruptive. The use of such adaptable elements however normally requires additional work, and the provision of such elements entails additional costs. Also, it cannot be ensured in all cases that the degrees of freedom in which adaptation is possible are suitable for compensating for all tolerances.

In particular, such transmission elements may be used for example for the mechanical control of an exhaust gas turbocharger where, in some designs, a transmission element is provided in the form of a lever for controlling a bypass valve on the turbine side. The valve on the turbine side is controlled by means of the transmission element by the boost pressure achieved or generated on the compressor side using a pressure cell.

On the compressor side, the exhaust gas turbocharger creates a sufficient charge pressure for the internal combustion engine to improve the degree of filling and hence the performance of the engine.

Since there is a trend towards greater charging as engine power increases, normally a boost pressure control system is provided in exhaust gas turbochargers. In such a boost pressure control system, a bypass valve (also called a wastegate) is provided in the exhaust gas flow on the turbine side. Above a specific charge pressure achieved on the compressor side, the bypass valve on the turbine side is opened by means of a transmission element so that the turbine is no longer driven by the entire exhaust gas flow and hence its rotation speed is limited.

In order to make said boost pressure control system work suitably, the transmission element must be mounted reliably, in particular also with adjustment, between the actuator on the compressor side and the adjusting element/bypass valve on the turbine side, in order also to allow compensation for production and assembly tolerances.

Previously, such tolerances were compensated by adjustable screws/threaded nuts.

In the context of the prior art, the present invention is based on the object of providing a method for producing a mechanical device with a mechanical transmission element, which allows simple installation and hence reliable compensation for tolerances. The object of the invention is also to provide a corresponding transmission element suitable for said purpose.

This object is achieved with the features of the invention according to claim 1 by a method for production of a mechanical device. The sub claims specify advantageous embodiments of the invention. The object is also achieved by a transmission element according to the invention as given in claims 10 and 13. Again, in relation to the transmission element, the sub claims specify advantageous embodiments.

The invention consequently relates to a method for producing a mechanical device, in particular an exhaust gas turbocharger, comprising a control or regulating device and a mechanical transmission element which is connected directly or indirectly firstly to an actuator and secondly to an adjusting element for transmission of a manipulated variable, wherein the transmission element is deformable before connection to the actuator and the adjusting element, and in deformable state is adapted to the other components of the device and after adaptation fixed by reducing its deformability.

Thus the deformability may comprise a possible compression movement, an expansion movement, or one or more bendings, also in different planes. The reduction of the deformability may be achieved by changing material properties, in particular the elasticity or plasticity, or by the addition of material connected to the material of the transmission element.

An advantageous embodiment of the invention provides that the transmission element is fixed after it has been connected firstly to the actuator and secondly to the adjusting element. In this case, the transmission element is initially adapted to the other parts of mechanical device and connected firstly to the actuator and secondly to the adjusting element with simultaneous adjustment, and then its deformability reduced. This variant is particularly simple if the measures necessary to reduce the deformability can also be carried out easily on the transmission element in fitted state inside the mechanical device.

It may however also be provided that the transmission element is fixed before it has been connected firstly to the actuator and secondly to the adjusting element. In this case, the transmission element may first be adapted to the other parts of the mechanical device but not yet joined to these, in particular not yet connected firstly to the actuator and secondly to the adjusting element. In this suitably deformed shape, the transmission element may first be removed from the mechanical device again and treated separately such that its deformability is reduced, and then it can be definitively assembled with the other parts of the mechanical device. This variant allows other more complex methods for reducing the deformability of the transmission element, since this can be treated separately from the other parts of the mechanical device.

A further advantageous embodiment of the invention provides that the transmission element is stiffened by a material stiffening. In this case, the transmission element consists at least partly of material of which the elasticity modulus can be changed by corresponding treatment in the case of an elastic material, or which can be stiffened by chemical reactions such as for example by cross-linking. The correspondingly stiffenable material which may constitute either the entire transmission element or individual parts of the transmission element, in particular individual deformability regions, may from the outset form part of the transmission element or be added to the transmission element during production of the mechanical device.

For this, it may be advantageous that at least one cavity of the transmission element can be filled at least partially with a stiffenable material. For example, the transmission element may comprise hose-like portions which can be suitably formed and bent on mounting, and then later filled with a stiffenable material, in particular a hardenable liquid resin. The resin can then be hardened to create a stiff form of the entire transmission element. Also, rubber-like substances may be used which could harden by cross-linking, or thermal effects may be used, such as for example in thermoplastic substances which could be introduced into cavities of the transmission element in liquid form and then stiffen by cooling.

A further advantageous embodiment of the invention provides that at least part of the transmission element is stiffened by the use of wave or particle radiation and/or heat radiation or chemical action. Said methods include all possibilities which could serve to bring about a change in the molecular structure of a material constituting at least part of the reinforcing regions of the transmission element, in order there to achieve a higher strength. Usually, to this end energy is introduced by radiation or similar actions which cause cross-linking.

The invention may also be advantageously configured in that the transmission element is stiffened by changing a geometric form. Here for example it is provided that in the pivot regions, easily deformable geometric forms such as flat sheets are used which however, after production of the intended final shape, can be formed into profiles which can no longer easily be deformed, such as for example profiles with semicircular or trough-like cross-section. Also, different parts of the transmission element may be placed in relation to each other such that they fix each other and cooperate as a framework in order to achieve a stiffening of the entire element.

The invention may also be advantageously configured in that the transmission element is stiffened by fixing of pivot regions provided between its different parts. Whereas it is however also possible to subject the entire material of the transmission element to treatment and thus stiffen it, it appears particularly advantageous to provide individual deformability regions/pivot regions which are particularly easily deformable before stiffening, and which can be stabilized by stiffening. In particular, for example two such pivot regions may be provided in a transmission element.

A further advantageous embodiment of the invention provides that the transmission element is stiffened by the production of connections between individual parts of the transmission element. With a clamp applied, different parts of the transmission element which each lie on different sides of a pivot region can be fixed to each other by force fit. A form-fit fixing is also conceivable by fitting a corresponding bar.

It may also be considered to apply a web, a strip or a welding rib in the surface region of the transmission element, and fix this to the transmission element continuously or in spots to achieve a stiffening.

A further advantageous embodiment of the method according to the invention provides that the adaptation of the transmission element is achieved by bending or folding of at least two deformability regions of the transmission element in different planes. The deformability regions of the transmission element may from the outset allow a deformation in only one plane per deformability region, so that a shape adaptation in several planes is possible by deformation of several deformability regions. This has the advantage that to stabilize the entire transmission element, then each deformability region need only be fixed in a single plane by stiffening.

The necessary shapes to be created for the transmission element for adaptation to the other parts of the mechanical device can nonetheless be achieved with a suitable selection of the degrees of freedom.

It is particularly easy to fix the deformability regions, if these only allow deformability in one plane, by clamping by means of a clamp or a bar if this type of fixing is preferred.

In addition to a method for production of a mechanical device with a transmission element, the invention also relates to such a transmission element which can be used in the manner according to the invention. To this extent, according to the invention a transmission element is provided for transmitting a manipulated variable between an actuator firstly and an adjusting element secondly, wherein at least one deformability region is provided in which the transmission element can be deformed, in particular bent, before adaptation and which can be stiffened by the change of material properties or by the addition of a further material.

Such a transmission element may advantageously be configured in that it consists at least partially of a hardenable material or can be filled with a hardenable material. To this end, it may comprise a corresponding cavity with a filling valve. The cavity may extend over several deformability regions, or a separate cavity may be provided for each deformability region, for filling with hardenable material.

A further embodiment of the invention provides a transmission element for transmission of a manipulated variable between an actuator firstly and an adjusting
element secondly, which is characterized by at least one, in particular two deformability regions in which the transmission element can be deformed, and by one or more cavities which can be filled with a stiffenable material.

The invention is depicted and explained in more detail below with reference to an exemplary embodiment in the figures of a drawing. The drawing shows:

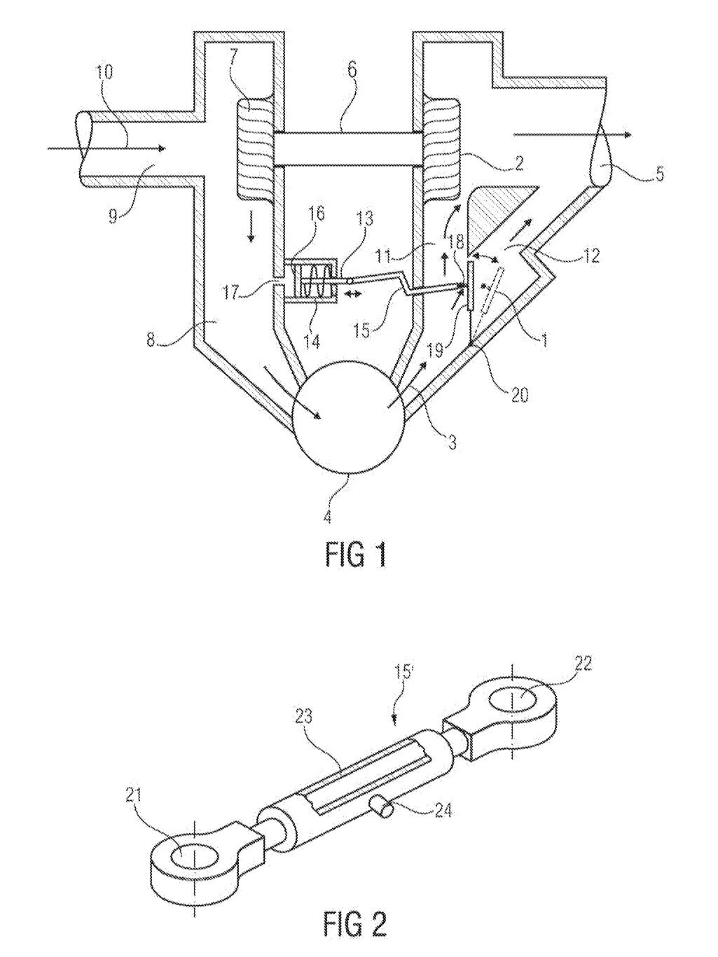

FIG. 1 diagrammatically, a cross-section of an exhaust gas turbocharger,

FIG. 2 diagrammatically, a three-dimensional view of a transmission element,

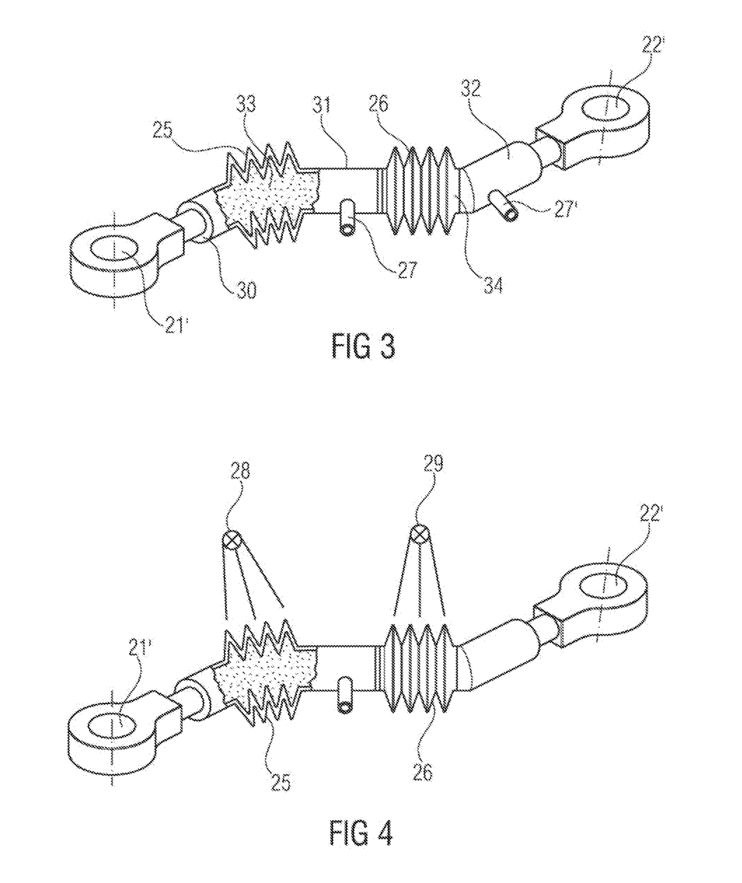

FIG. 3 a view of a further transmission element,

FIG. 4 a view of a transmission element during a hardening process,

FIG. 5 a further transmission element,

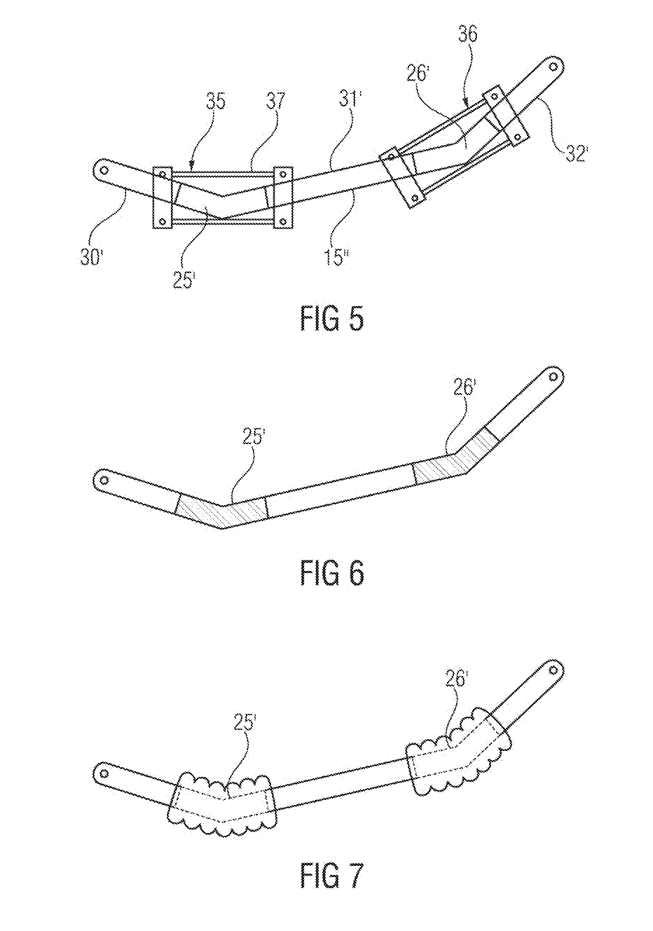

FIG. 6 a further depiction of a transmission element with two pivot regions, and

FIG. 7 a further depiction of a transmission element.

FIG. 1 shows diagrammatically a mechanical device in the form of an exhaust gas turbocharger with a so-called wastegate 1. In principle, such an exhaust gas turbocharger has a turbine part with a turbine 2 which moves in the exhaust gas flow 3 and is driven thereby. The exhaust gas flow 3 is expelled from the combustion chambers of an internal combustion engine 4 (indicated diagrammatically) and moved through an outlet channel 5 to an exhaust system. Energy is extracted from the gas flow of the exhaust gas by the turbine 2.

The turbine 2 is connected to the compressor 7 via a rotatable shaft 6 of the turbocharger with multiple mountings, such that the turbine 2 drives the compressor 7 directly via the shaft 6. The compressor 7 is in turn positioned in an intake channel 8 through which fresh air is aspirated via an intake connection 9 and moved to the internal combustion engine 4, or more precisely to its combustion chambers.

The intake gas flow 10 is compressed by the compressor 7 and charged to a higher intake pressure. Thus a greater quantity of fresh air at high pressure level is available to the internal combustion engine 4, which leads to an increase in power of the internal combustion engine 4.

As the power of the internal combustion engine 4 increases, the power of the turbine 2 increases and hence also the charging by the compressor 7. The temperature of the intake gas flow 10 rises, wherein the intake gas flow may be cooled by a charge cooler provided in the intake channel 8. However the charge pressure must be prevented from exceeding certain limits, since firstly the load on the engine can rise undesirably and secondly thermal loads, in particular in the outlet channel 5, can become excessive.

To control the charging of the turbocharger, a so-called wastegate 1 is provided as a bypass valve for the exhaust gas flow 3. The exhaust gas flow 3 can be conducted to the outlet channel 5 on the path via the turbine 2 or the channel 11 leading thereto, or past the turbine 2 via the bypass channel 12 through the wastegate valve 1.

The wastegate 1 is controlled mechanically via an actuator 13 of a pressure measurement sensor 14 by means of a transmission element 15. The actuator 13 may for example be configured as a ram which is connected to a piston 16 or the membrane in a pressure cell. The piston 16 or the membrane are exposed to the charge pressure on the compressor side of the turbocharger inside the pressure cell via an orifice 17 which creates the connection between the intake channel 8 and the interior of the pressure measuring sensor 14. At high boost pressure therefore the piston or membrane 16 is pressed to the right in FIG. 1, so that this movement continues via the transmission element 15 to the wastegate valve 1. A ram 18 at the wastegate 1, which is connected to a valve flap 19, thus together with the valve flap constitutes the adjusting element of the valve. In FIG. 1, the valve flap 19 is shown in two positions between which the valve flap can be moved by a pivot movement about a hinge point 20. Thus the bypass channel 12 is blocked in one position of the valve flap and opened in the other position.

The embodiment of the wastegate 1 as described constitutes just one of the possible designs of a mechanically controllable valve.

It is clear from the description above that the length and shape of the transmission element 15 and the mounting tolerances on the left side, firstly in the connection to the actuator 13 and secondly in the connection to the ram 18, determine the charge pressure at which the valve flap 19 is closed and the charge pressure at which it opens.

The mounting and adjustment of the transmission element 15 between the actuator 13 and the ram 18, or the adjusting element consisting of the ram 18 and valve flap 19, is therefore decisive for the desired function of the turbocharger.

According to the invention, the transmission element 15 is deformable before mounting so that for installation it is bent into the desired shape and length, or can otherwise be deformed. During the mounting steps, the transmission element can then be stiffened at least in part so as to stabilize the state created on installation in which the tolerances can be compensated desirably. For this reason, no further adjustment possibilities at the transmission element are required.

FIG. 2 shows as an example a transmission element 15′ with a first pivot eye 21 for pivoting on the actuator 13, and a second pivot eye 22 for pivoting on the ram 18. A cavity 23 is provided between the pivot eyes 21, 22, which is shown partly broken away and which can be filled with a hardenable resin via a valve 24 for example. Thus the resin-filled transmission element 15′ is first brought into shape, i.e. compressed or bent, on installation and then hardened. Hardening may take place for example by the addition of a chemically active hardening component, by heat action or by radiation.

Hardening may take place both in fitted state between the actuator 13 and the ram 18, and in the preformed state after removal from the turbocharger, wherein in this case the transmission element 15′ is refitted after hardening.

FIG. 3 shows a view of a transmission element with three fixed regions 30, 31, 32 which alternate with two deformability regions 25, 26 along the longitudinal extension of the transmission element. Each deformability region 25, 26 lies between two fixed regions 30, 31, 32. On their outside, the deformability regions 25, 26 have peripheral ribs running in the circumferential direction to compensate for bending movements, and in the interior a respective hollow cavity 33, 34, or a common connected cavity. The individual cavities can be filled by means of valve 27, 27′ with a hardenable material, for example a vulcanizable rubber or a hardenable casting resin.

The pivot eyes 21′, 22′ of the transmission element can thus be connected on installation firstly to the actuator 13 and secondly to the adjusting element/ram 18, and thus the transmission element can be bent into the correct shape. The individual deformability regions/pivot regions 25, 26 may here each have preferred planes in which they are bendable.

After adaptation or even before adaptation, the cavities 33, 34 may be filled and the inserted material can be stiffened after adaptation.

FIG. 4 shows for further details a similar transmission element to that in FIG. 3, wherein also two radiation sources 28, 29 are shown which allow the radiation of the cavities 33, 34 in the deformability regions 25, 26 for stiffening the entire transmission element. Such radiation sources may be provided stationarily and serve for removal of the transmission element for hardening from the turbocharger and separate hardening, or they may also be transportable for use in stiffening the transmission element in mounted state.

FIG. 5 shows a transmission element 15″ in which two deformability regions/pivot regions 25′, 26′ are fixed by clamps 35, 36. The clamps 35, 36 each have clips which can be clamped to the fixed regions 30′, 31′, 32′ by means of screw connections, and connecting rods 36, 37 to fix or stiffen the clamps 35, 36 beyond the deformation regions. This variant has the advantage that by removing or loosening the clamps 35, 36, further adjustment of the transmission element is possible since the deformation regions 25′, 26′ are not stiffened in themselves. They may for example consist of a relatively stiff rubber.

FIG. 6 shows for clarification the division of a transmission element 15″ from FIG. 5 into fixed regions and deformation regions 25′, 26′ without clamps.

FIG. 7 shows diagrammatically a transmission element similar to that shown in FIG. 6, wherein the deformation regions/pivot regions 25′, 26′ are indicated merely in dotted lines and wherein the deformation regions are stiffened by externally applied hardenable wrappings. Such wrappings may for example be made of fiber fleece which is or can be impregnated with a hardenable resin. These can be hardened after adaptation of the transmission element to stiffen the transmission element 15″ in the same way as a material introduced into the interior of corresponding cavities.

1-13. (canceled)

14. A method for producing an exhaust gas turbocharger, which comprises:
providing a control or regulating device;
providing an actuator;
providing an adjusting device; and
providing a mechanical transmission element connected directly or indirectly first to the actuator and second to the adjusting element for transmission of a manipulated variable, the mechanical transmission element being deformable before connection to the actuator and the adjusting device, and in a deformable state the mechanical transmission element is adapted to other components of the exhaust gas turbocharger and after adaptation the mechanical transmission element is fixed by reducing its deformability.

15. The method according to claim 14, which further comprises fixing the mechanical transmission element after the mechanical transmission element has been connected first to the actuator and second to the adjusting element.

16. The method according to claim 14, which further comprises fixing the mechanical transmission element before the mechanical transmission element has been connected first to the actuator and second to the adjusting element.

17. The method according to claim 14, wherein the mechanical transmission element is stiffened by material stiffening.

18. The method according to claim 14, which further comprises filling at least one cavity of the mechanical transmission element at least partially with a stiffenable material.

19. The method according to claim 17, which further comprises stiffening at least part of the mechanical transmission element by use of at least one of wave or particle radiation, heat radiation or chemical action.

20. The method according to claim 14, which further comprises stiffening the mechanical transmission element by changing a geometric form of the mechanical transmission element.

21. The method according to claim 14, which further comprises stiffening the mechanical transmission element by fixing pivot regions provided between different parts of the mechanical transmission element.

22. The method according to claim 14, which further comprises stiffening the mechanical transmission element by a production of connections between individual parts of the mechanical transmission element.

23. The method according to claim 14, wherein the adaptation of the mechanical transmission element is achieved by bending or folding of at least two deformability regions of the mechanical transmission element in different planes.

24. A transmission element for transmitting a manipulated variable between an actuator first and an adjusting element second, the transmission element comprising:
at least one deformability region in which the transmission element can be deformed before adaptation and which can be stiffened by a change of material properties or by an addition of a further material.

25. The transmission element according to claim 24, wherein the transmission element is formed at least partially of a hardenable material.

26. The transmission element according to claim 24, wherein said at least one deformability region is bendable.

27. A transmission element for transmission of a manipulated variable between an actuator first and an adjusting element second, the transmission element comprising:
at least one deformability region in which the transmission element can be deformed; and
a cavity to be filled with a stiffenable material.
